(19) United States
(12) Patent Application Publication
(10) Pub. No.: US 2010/0231576 A1
(43) Pub. Date: Sep. 16, 2010

(54) DIGITAL PHOTO FRAME WITH MIRROR FUNCTION

(75) Inventors: MING-FENG TSAI, Tu-Cheng (TW); CHENG-HAO CHOU, Tu-Cheng (TW); KUAN-HONG HSIEH, Tu-Cheng (TW); XIAO-GUANG LI, Shenzhen City (CN)

Correspondence Address: Altis Law Group, Inc.;ATTN: Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD, ShenZhen City (CN); HON HAI PRECISION INDUSTRY CO., LTD., Tu-Cheng (TW)

(21) Appl. No.: 12/479,697

(22) Filed: Jun. 5, 2009

(30) Foreign Application Priority Data
Mar. 13, 2009 (CN) 200920301288.0

(51) Int. Cl. G09G 5/00

(52) U.S. Cl. 345/212

(57) ABSTRACT

A digital photo frame (DPF) includes a power management unit, a display panel, a backlight unit, an image capturing unit and a processing unit. The display panel includes a reflective structure. The power management unit is used to manage the power supply from a power source to the DPF. The backlight unit connects with the display panel and the power management unit. The image capturing unit is used to capture images of objects around the DPF and produce a detection signal when the image includes a face of a person. The processing unit connects with the image capturing unit and the power management unit, the processing unit controls the power management unit to discontinue the power from the power source to the backlight unit when receiving the detection signal, therefore the display panel reflects images via the reflective structure.

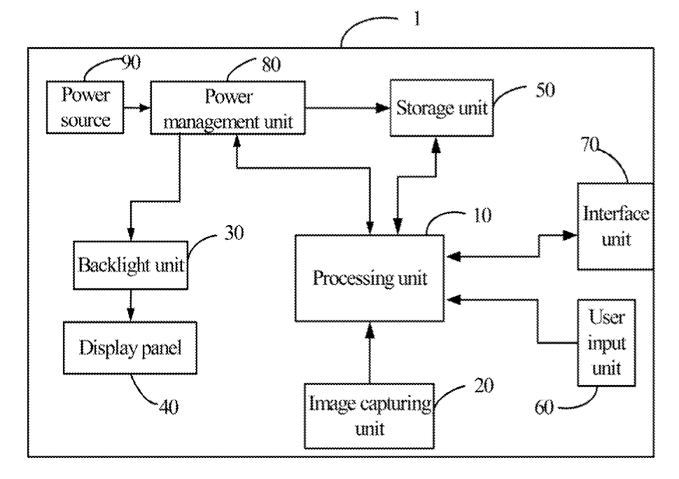

### RELATED APPLICATIONS

This application is related to co-pending applications entitled, “DIGITAL PHOTO FRAME WITH MIRROR FUNCTION”, filed ______ (Atty. Docket No. US 22328); and “DIGITAL PHOTO FRAME WITH MIRROR FUNCTION”, filed ______ (Atty. Docket No. US22330).

### BACKGROUND

1. Technical Field

The disclosure relates to electronic devices and, particularly, to a digital photo frame.

2. Description of Related Art

Nowadays, digital photos are getting more and more popular while digital cameras are becoming more and more affordable. Accordingly, in order to display digital photos, digital photo frames (DPFs) are invented.

Like the traditional photo frames, many digital photo frames can be either placed on a table or mounted on a wall. Because of their popularity, it would be useful if digital photo frames could serve other purposes as well.

Therefore, it is useful to provide a digital photo frame with additional functionality.

### BRIEF DESCRIPTION OF THE DRAWINGS

The components in the drawing is not necessarily drawn to scale, the emphasis instead being placed upon clearly illustrating the principles of the digital photo frame.

The drawing is a block diagram of a digital photo frame in accordance with an exemplary embodiment.

### DETAILED DESCRIPTION

Referring to the drawing, a digital photo frame (DPF) 1 includes a processing unit 10, an image capturing unit 20, a backlight unit 30, a display panel 40, a storage unit 50, a user input unit 60, an interface unit 70 (e.g., an input port or a wireless transceiver), a power management unit 80, and a power source 90.

The interface unit 70 is configured to connect to an external electronic device (not shown). The external device can be a storage card (e.g., a secure digital SD card, a compact flash CF card) or another electronic device (e.g., a digital camera, a mobile phone, or a computer).

The user input unit 60 is configured to generate instructions in response to user operations. The user input unit 60 can be input keys/buttons, knobs, and the like. The power management unit 80 is configured to distribute power from the power source 90 to elements of the DPF 1, such as the processing unit 10, the backlight unit 30, and the display panel 40.

The storage unit 50 is configured to store medias such as digital pictures. The display panel 40 is configured to display the medias. The backlight unit 30 is configured to illuminate the display panel 40 from the side or back of the display panel 40. The backlight unit 30 can be incandescent light bulbs, light-emitting diodes (LEDs), an electroluminescent panel (ELP), one or more cold cathode fluorescent lamps (CCFL), and hot cathode fluorescent lamps (HCFL), or the like.

In the embodiment, the display panel 40 is a multilayer panel. One layer excepting the surface of the display panel 40 is plated with reflective material, such as aluminum, bronze, and silver, and so on. The reflective material enables the display panel 40 to reflect images like a mirror when the backlight unit 30 is turned off.

In another embodiment, the surface of the display panel 40 is covered with a reflective film, the reflective film also comprises a multilayer structure and one layer excepting the surface of the reflective film is plated with reflective material. The layer of the reflective film can be an aluminum plated layer, a silver plated layer, a bronze plated layer, or the like.

The image capturing unit 20, connected to the processing unit 10, is configured for capturing images of objects around the DPF 1 and determining whether a captured image includes a face of a person, and determining the distance between the person and the DPF 1 in case that the image includes a face of a person. The image capturing unit 20 is also configured for producing a detection signal to the processing unit 10 when the image includes a face of a person and the distance between the person with the DPF 1 is less than a predetermined distance (e.g., 0.2 meter). In the embodiment, the image capturing unit 20 determines the distance between the person and the DPF 1 according to the size of the face of the captured image, in detail, the image capturing unit 20 compares the size of the face with a predetermined face size, if the size of the face is larger than the predetermined face size, then the image capturing unit 20 determines that the distance between the person and the DPF 1 is less than the predetermined distance, otherwise, the image capturing unit 20 determines that the distance between the person and the DPF 1 is greater than the predetermined distance. In the embodiment, the image capturing unit is a camera.

The processing unit 10 is configured to control the power management unit 80 to discontinue the power from the power source 90 to the backlight unit 30 when receiving the detection signal. Thereupon, the backlight unit 30 is turned off and the display panel 40 can be used as a mirror by the person. Namely, the DPF 1 is taken as a mirror when there is a person around the DPF 1 within a relatively short range.

In the embodiment, the image capturing unit 20 continuously captures images of objects around the DPF 1. The image capturing unit 20 is also configured to produce a power-on signal when it detects that a captured image without a face of a person or detects that a captured image includes a face of a person but the distance between the person and the DPF 1 is greater than the predetermined distance. The processing unit 10 is also configured for controlling the power management unit 80 to provide power from the power source 90 to the backlight unit 30 when receiving the power-on signal. Then, the display panel 40 displays the media again when there is nobody right before the DPF 1 who is assumed to want to use the DPF as a mirror.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the present disclosure.

What is claimed is:

1. A digital photo frame (DPF) comprising:
a power management unit connected to a power source, configured for distributing power from the power source to the DPF;
a display panel comprising a reflective structure;
a backlight unit connected to the power management unit, configured for illuminating the display panel when turned on;
an imaging capturing unit configured for capturing an image of objects around the DPF and determining the distance between a person and the DPF when the image includes a face of the person, and producing a detection signal if the distance between the person and the DPF is less than a predetermined distance; and
a processing unit connected to the imaging capturing unit, configured for controlling the power management unit to discontinue power from the power source to the backlight unit when receiving the detection signal.

2. The DPF of claim 1, wherein the image capturing unit continuously captures images of objects around the DPF, if the image capturing unit detects that a captured image does not include a face of a person or the distance between the person and the DPF is greater than the predetermined distance, the image capturing unit produces a power-on signal, the processing unit is further configured for controlling the power management unit to provide power to the backlight unit when receiving the power-on signal.

3. The DPF of claim 2, wherein the image capturing unit determines the distance between the person and the DPF according to the size of the face of the person in the captured image.

4. The DPF of claim 1, wherein the display panel comprises a multilayer structure, the reflective structure is one layer excepting the surface of the display panel plated with reflective material.

5. The DPF of claim 4, wherein the reflective material is selected from the group consisting of aluminum, bronze, and silver.

6. The DPF of claim 1, wherein the reflective structure is a reflective film covering the display panel, and the reflective film comprises a multilayer structure and one layer excepting the surface of the reflective film is plated with reflective material.

7. The DPF of claim 6, wherein the reflective material is selected from the group consisting of aluminum, bronze, and silver.

8. The DPF of claim 3, wherein the image capturing unit is a camera.

9. A method of changing the display state of a digital photo frame (DPF), the DPF comprising:
a power management unit;
a display panel comprising a reflective structure;
a backlight unit for illuminating the display panel
an image capturing unit;
a processing unit,
the method comprising:
capturing an image of objects around the DPF via the image capturing unit;
determining whether the captured image includes a face of a person via the image capturing unit;
determining the distance between the person and the DPF when the image capturing unit determines that the captured image includes the face of the person;
producing a detection signal when the image capturing unit determines the distance between the person and the DPF is less than a predetermined distance; and
controlling the power management unit to discontinue the power from a power source to the backlight unit when the processing unit receives the detection signal, therefore, the backlight unit being turned off and the display panel reflecting images by the reflective structure.

10. The method of claim 9, further comprising:
producing an power-on signal via the image capturing unit when it detects that the captured image does not include a face of a person or the distance between the person and the DPF larger than the predetermined distance;
controlling the power management unit via the processing unit to provide the power from the power source to the backlight unit when the processing unit receives the power-on signal.

11. The method of claim 10, wherein the image capturing unit determines the distance between the person and the DPF according to the size of the face of the person in the captured image.
